(19) United States
(12) Patent Application Publication
(10) Pub. No.: US 2024/0332869 A1
(43) Pub. Date: Oct. 3, 2024

(54) ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: XIAO FAN, Huaian (CN); Jun CHEN, Kunshan (CN); YANG-TSUN HSU, New Taipei (TW)

(21) Appl. No.: 18/621,911

(22) Filed: Mar. 29, 2024

(30) Foreign Application Priority Data
Mar. 30, 2023 (CN) 202310323482.3

(51) Int. Cl. H01R 13/6591; H01R 13/6471

(52) U.S. Cl. CPC H01R 13/6591; H01R 13/6471

(57) ABSTRACT

An electrical connector assembly includes an electrical connector and a cable. The electrical connector includes a frame, a signal terminal pair, a grounding member provided on both sides of signal terminal pair, and a shielding member connected to the grounding member. The cable includes a signal conductor pair and a ground conductor. The shielding member includes a shielding plate with an inner plate, an outer plate, and a middle plate. Each of the inner plate, the outer plate, and the middle plate includes a plate portion provided on the other side of the frame relative to the cable, each of the middle plate and the outer plate includes multiple first protrusion portions extending from the plate portion through the frame to the side of the cable, and the first protrusion portions are disposed between adjacent pairs of signal conductors to reduce crosstalk between adjacent pairs of signal conductors.

### BACKGROUND OF THE INVENTION

### Field of the Invention

The present invention relates to an electrical connector assembly to transmit high-frequency signals.

### Description of Related Arts

The field of high-speed data transmission technology has increasingly higher requirements for the electrical performance of electrical connectors. Electrical connectors must be able to reliably transmit data signals and ensure signal integrity, and their sizes are becoming increasingly miniaturized, which makes the electrical connectors multiple terminals are arranged at a higher density. Since the spacing between signal terminals is smaller, the crosstalk will occur between pairs of signal terminals, especially between pairs of adjacent differential signal terminals, which will affect the signal integrity of the entire signal transmission system. U.S. Pat. No. 11,495,909, issued on Nov. 8, 2022, discloses a receptacle connector including an insulator housing and a terminal wafer. The terminal wafer includes a terminal array, a terminal support molding, and a ground shielding adjacent the terminal support molding. The terminal array includes a plurality of signal terminals and a plurality of ground terminals, each ground terminal having a grounding aperture. The terminal support molding is disposed about and supports the signal terminal and the around terminals of the terminal array and includes a plurality of mold openings aligned with the grounding apertures. The ground shielding may be assembled from a relatively thin, flat projection plate and a relatively thicker intermediate plate. To interconnect with the terminal array, the projection plate may include a plurality of grounding projections projecting therefrom to traverse the mold openings and received by the grounding apertures to mechanically and electrically connect with the ground terminals.

### SUMMARY OF THE INVENTION

A main object of the present invention is to provide an improved electrical connector assembly with better grounding and shielding performance and meeting high frequency characteristics requirements.

To achieve the above-mentioned object, an electrical connector assembly comprises: an electrical connector; comprising: a housing; a frame disposed in the housing; a terminal assembly and a grounding member which are configured to be supported in the frame, the terminal assembly comprising a plurality of signal terminal pairs and the grounding member comprising a plurality of ground terminals respectively provided on both sides of each pair of signal terminals; and a shielding member which is configured to be electrically connected to the grounding member, the shielding member comprising a shielding plate; a cable which is configured to be connected with the electrical connector; comprising: a plurality of signal conductor pairs which are configured to be connected to the signal terminal pairs; and a plurality of ground conductors which are configured to be electrically connected to the ground terminals, wherein the shielding plate comprises an inner plate disposed close to the grounding member, an outer plate disposed away from the grounding member, and an middle plate disposed between the inner plate and the outer plate, each of the inner plate, the outer plate, and the middle plate comprises a plate portion provided on the other side of the frame relative to the cable, each of the middle plate and the outer plate comprises a plurality of first protrusion portions extending from the plate portion through the frame to the side of the cable, and the plurality of first protrusion portions are disposed between adjacent pairs of signal conductors to reduce crosstalk between adjacent pairs of signal conductors.

Compared to prior art, the electrical connector assembly in the present invention can provide better grounding and shielding performance and meet high-frequency characteristic requirements.

### BRIEF DESCRIPTION OF DRAWINGS

FIG. 1 is a perspective view of an electrical connector assembly;

FIG. 2 is an another perspective view of the electrical connector assembly shown in FIG. 1;

FIG. 3 is an exploded view of the electrical connector assembly shown in FIG. 1;

FIG. 4 is a perspective view of the connector assembly and the cable of the electrical connector assembly shown in FIG. 3;

FIG. 5 is an another perspective view of the connector assembly and the cable shown in FIG. 4;

FIG. 6 is a sectional view of the connector assembly and the cable shown in FIG. 5 along line A-A, the spacers on the cable have been removed;

FIG. 7 is an exploded view of the connector assembly and the cable shown in FIG. 4;

FIG. 8 is an exploded view of the first connector and the first cable group shown in FIG. 7;

FIG. 9 is an another exploded view of the first connector and the first cable group shown in FIG. 8;

FIG. 10 is a perspective view of the terminal assembly and the grounding member shown in FIG. 8;

FIG. 11 is a perspective view of the shielding member of the first connector shown in FIG. 8;

FIG. 12 is an exploded view of the shielding member shown in FIG. 11;

FIG. 13 is a perspective view of the first connector shown in FIG. 7, wherein one signal terminal pair connected with a twin-ax cable;

FIG. 14 is an another perspective view of the first connector shown in FIG. 13;

FIG. 15 is a sectional view of the first connector shown in FIG. 14 along line B-B; and

FIG. 16 is a sectional view of the first connector shown in FIG. 14 along line C-C.

### DETAILED DESCRIPTION OF THE DRAWINGS

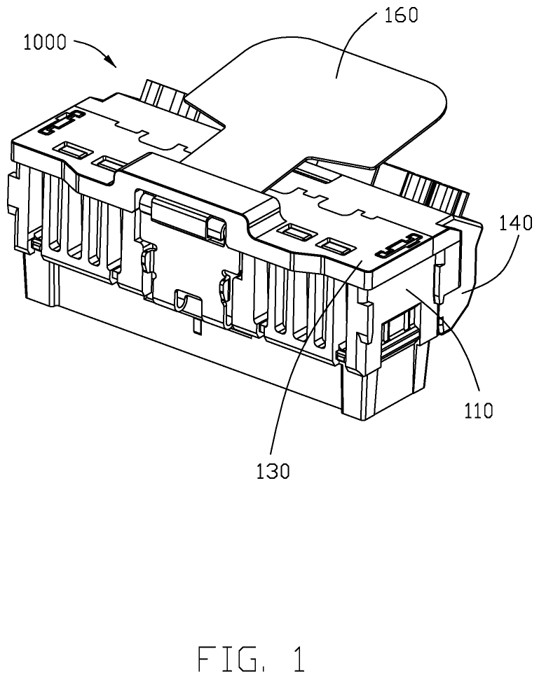

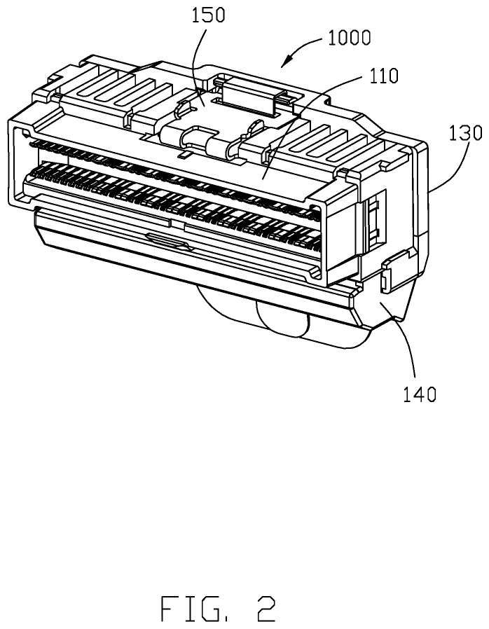

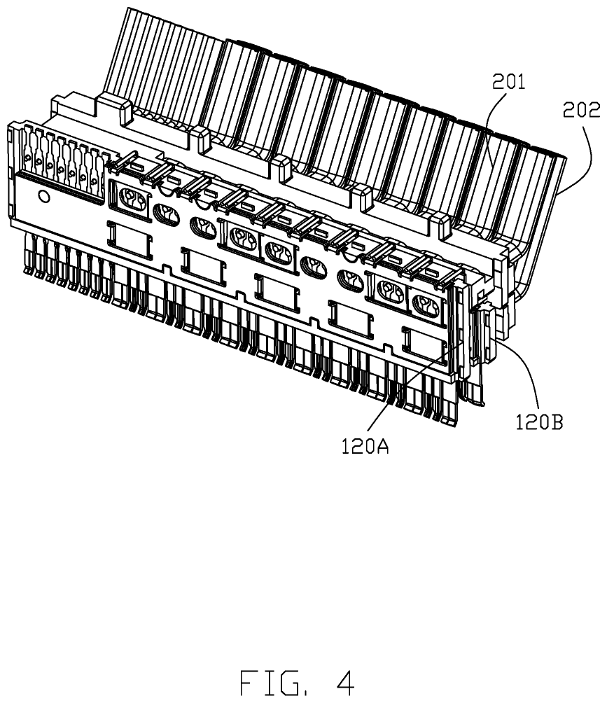

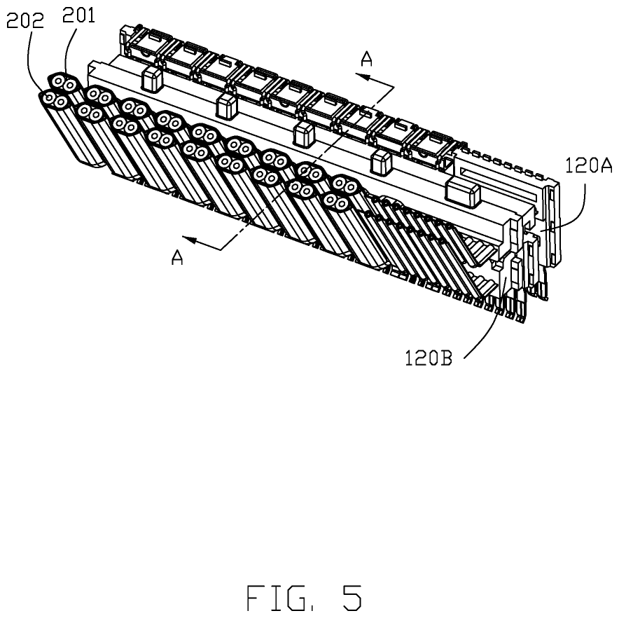

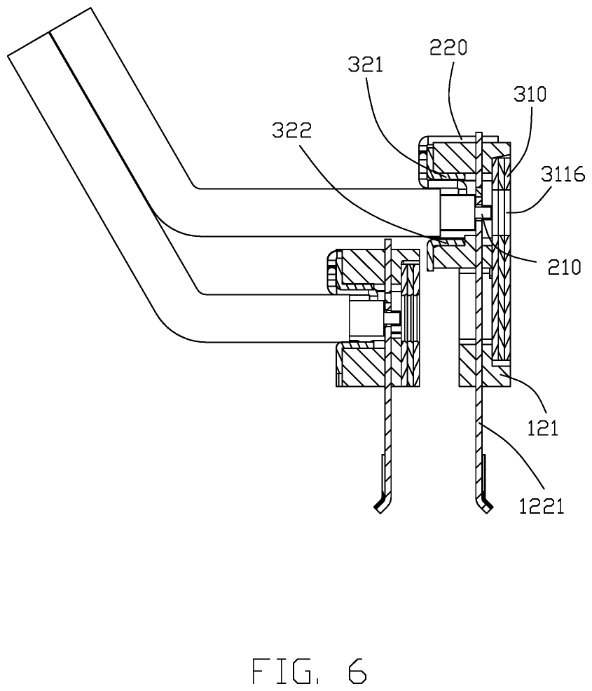

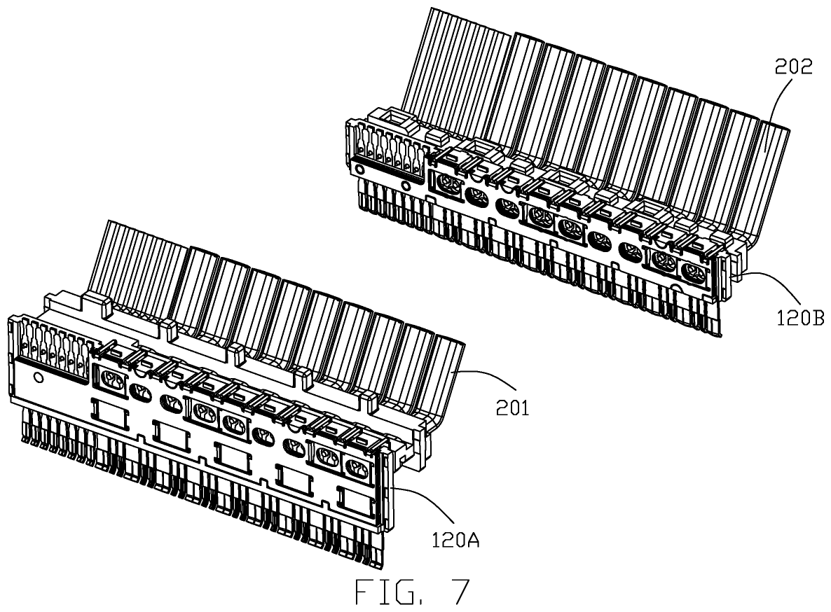

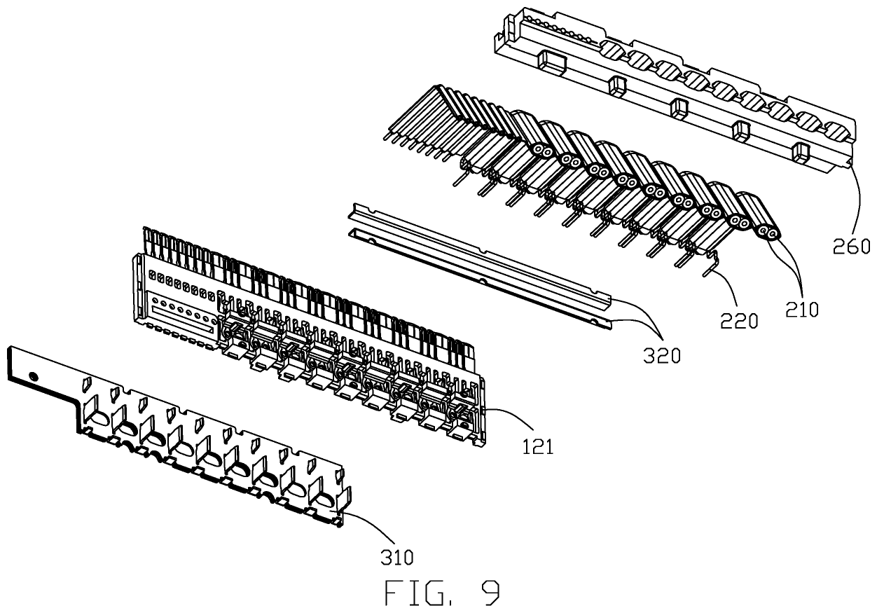

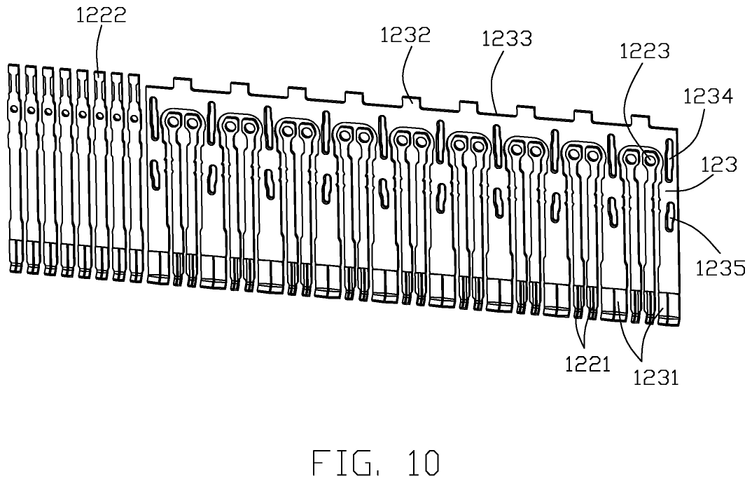

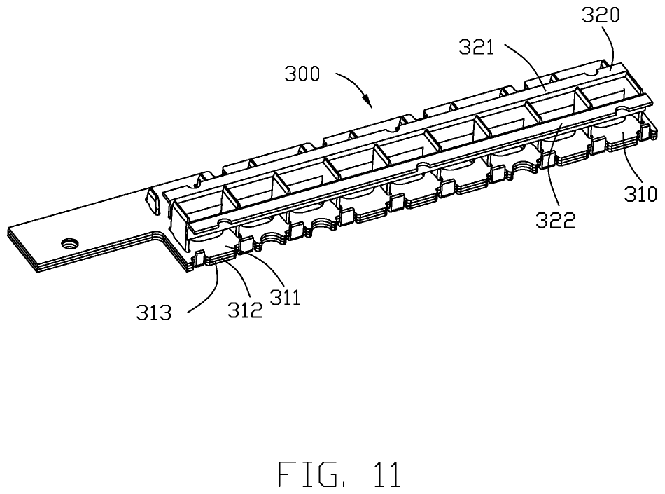

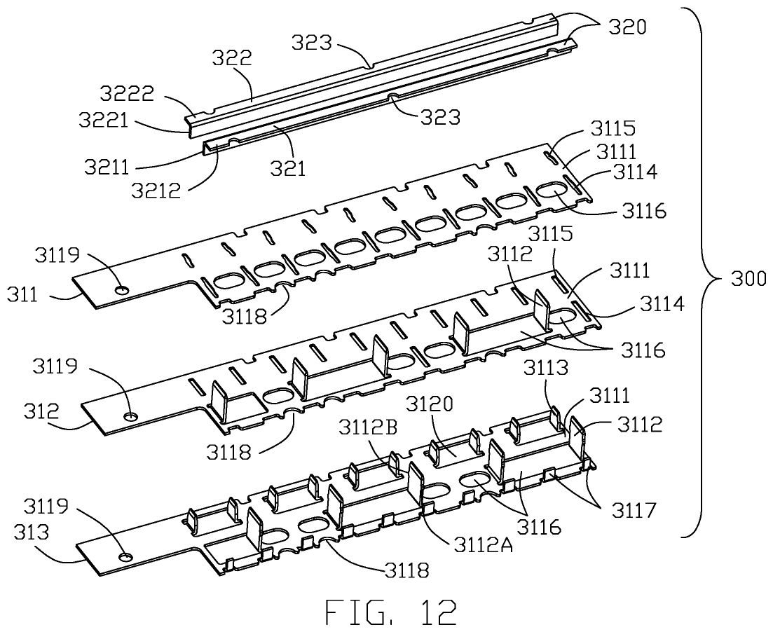

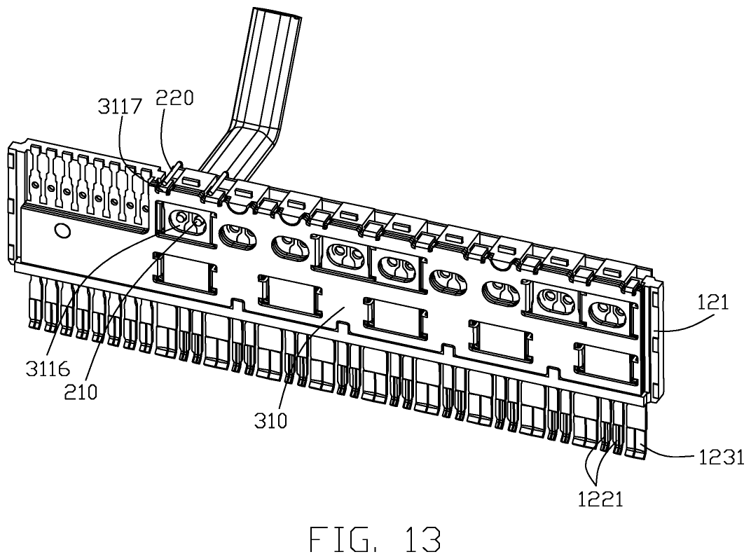

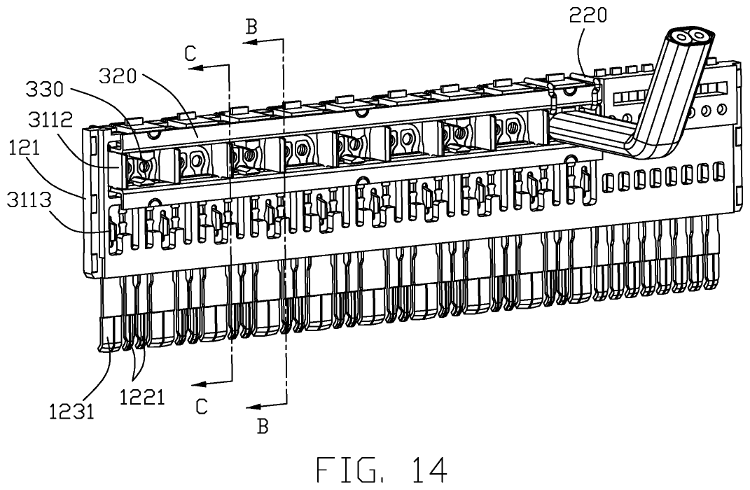

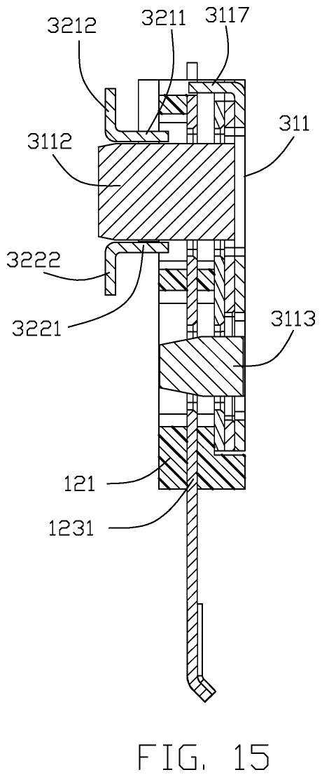

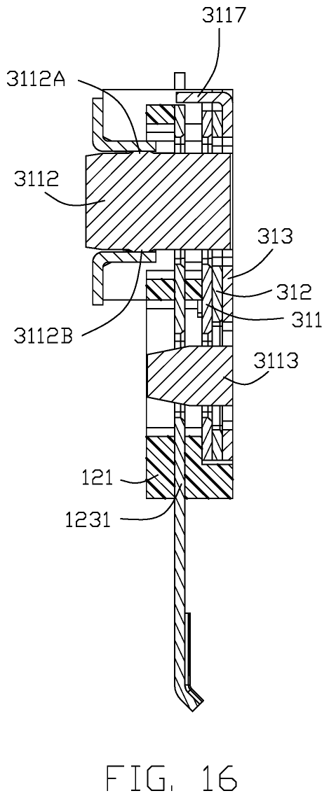

Referring to FIGS. 1-16, it shows the electrical connector assembly 1000 of the present invention. The electrical connector assembly 1000 includes an electrical connector 100 and a cable 200 connected with the electrical connector 100. The electrical connector 100 includes a housing 110, an upper cover 130 connected with the housing 110 and disposed above the housing 110, and a back cover 140 provided on one side of the cable 200 to support the cable 200. The upper cover 130 is also provided with a latch 150 that mated with a docking connector (not shown) and a pull tab 160 connected with the latch 150.

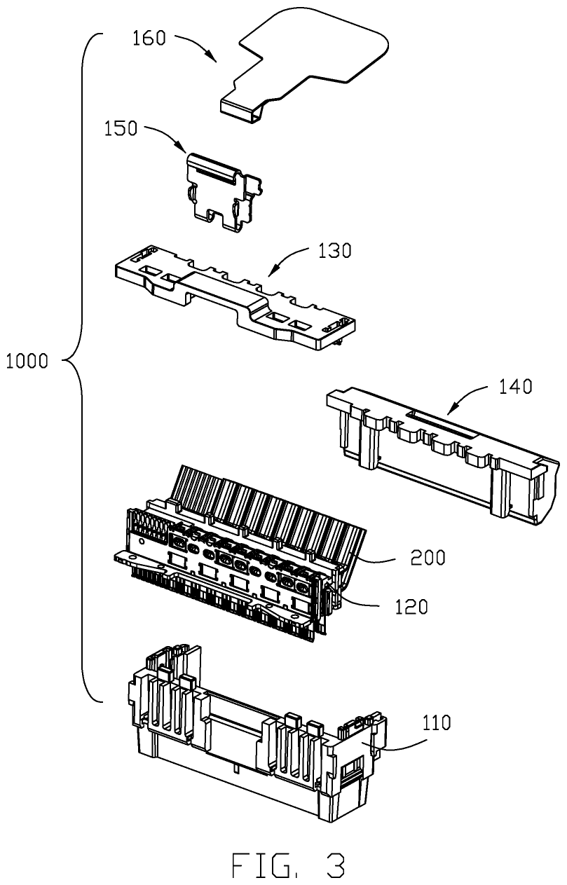

Referring to FIGS. 3-8, the electrical connector 100 includes a connector assembly 120 disposed in the housing 110 and connected with the cable 200. The connector assembly 120 includes a first connector 120A and a second connector 120B. The cable 200 includes a first cable group 201 connected with the first connector 120A and a second cable group 202 connected with the second connector 120B. The first cable group 201 and the second cable group 202 are both provided with a spacer 260 for holding cables. The first connector 120A and the second connector 120B have the same structural features and only differ in size. The following description takes the first connector 120A as an example.

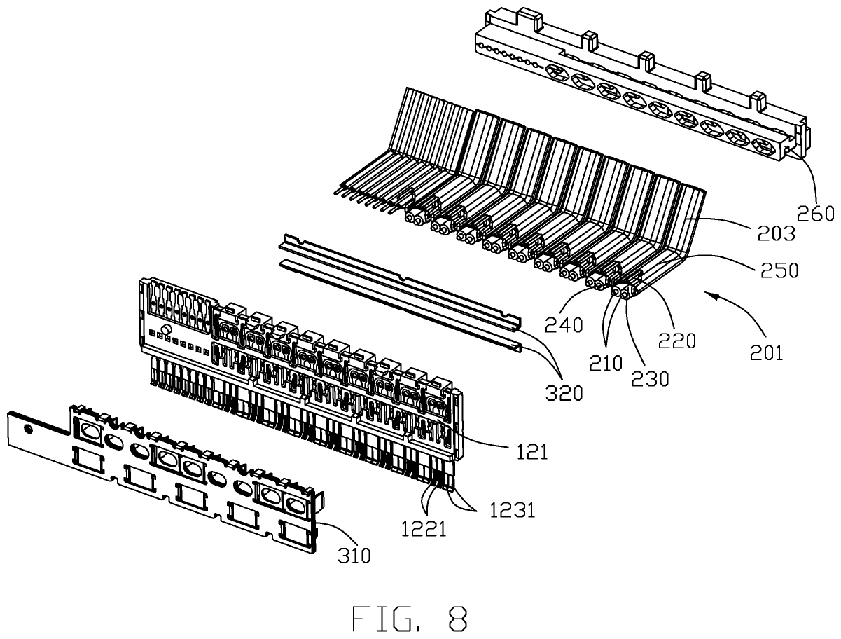

Referring to FIGS. 8-11, the first connector 120A includes a frame 121, a terminal assembly 122 and a grounding member 123 disposed in the frame 121, and a shielding member 300 electrically connected with the grounding member 123. The terminal assembly 122 includes a plurality of signal terminal pairs 1221. The grounding member 123 includes a plurality of ground terminals 1231 respectively provided on both sides of the signal terminal pair 1221. The first cable group 201 includes a plurality of twin-ax cables 203 arranged in a row. The twin-ax cable 203 specifically includes a pair of signal conductors 210, an inner insulation layer 230 covering the pair of signal conductors, a shielding layer 240 covering the inner insulation layer 230, an outer insulation layer 250 covering the shielding layer 240, and two ground conductors 220. The two ground conductors 220 are disposed between the shielding layer 240 and the outer insulation layer 250 and are respectively disposed on both sides of the signal conductor pair 210. The ends of the signal conductor pair 210 expose the inner and outer insulation layers and shielding layers covering the outside thereof and are connected with the signal terminal pair 1221. The end of the ground conductor 220 exposes the outer insulation layers and shielding layers covering the outside thereof and is electrically connected with the grounding member 123.

The shielding member 300 includes a shielding plate 310. The shielding plate 310 includes a plate portion 3111 disposed on the other side of the frame 121 relative to the cable 200 and a plurality of first protrusion portions 3112 extending from the plate portion 3111 through the frame 121 to one side close to the cable 200. The first protrusion portions 3112 are disposed between adjacent pairs of signal conductors 210 to reduce crosstalk between adjacent pairs of signal conductors 210 at this location.

Specifically, the terminal assembly 122 includes a plurality of signal terminal pairs 1221 and a plurality of low-speed signal terminals 1222 provided on one side of the signal terminal pairs 1221 for transmitting low-frequency signals. The signal terminal pair 1221 is provided with a connection hole 1223 penetrating the signal terminal pair 1221, the signal conductor pair 210 and the signal terminal pair 1221 are welded and connected at the connection hole 1223. The grounding member 123 includes a main body portion 1232 disposed above the signal terminal pair 1221 and a plurality of ground terminals 1231 disposed on both sides of the signal terminal pair 1221 to form a GSSG arrangement. The main body 1232 is provided with a groove 1233 through which the ground conductor 220 can extend. The ground terminal 1231 is provided with a first through groove 1234 and a second through groove 1235 provided below the first through groove 1234. The first protrusion portions 3112 can pass through the first through groove 1234 to the side of the cable 200. The terminal assembly 122 and the grounding member 123 are disposed in the frame 121 by insert molding.

The shielding plate 310 includes an inner plate 311 disposed close to the grounding member 123, an outer plate 313 disposed far away from the grounding member 123, and an middle plate 312 disposed between the inner plate 311 and the outer plate 313. The inner plate 311, the outer plate 313 and the middle plate 312 all include a plate portion 3111 provided on the other side of the frame 121 relative to the cable 200. The outer plate 313 and the middle plate 312 are provided with a plurality of first protrusion portions 3112 perpendicular to the plate portion 3111, and a plurality of first protrusion portions 3112 are staggered on the outer plate 313 and the middle plate 312. The outer plate 313 is also provided with a plurality of second protrusion portions 3113 below the first protrusion portions 3112, the size of the second protrusion portion 3113 is smaller than that of the first protrusion portions 3112. The middle plate 312 and the inner plate 311 are provided with first through slots 3114 at positions corresponding to the first protrusion portions 3112 for the first protrusion portions 3112 to extend through. The middle plate 312 and the inner plate 311 are provided with a plurality of second through slots 3115 at positions corresponding to the second protrusion portions 3113 for the second protrusion portions 3113 to extend through. When the inner plate 311, the middle plate 312 and the outer plate 313 are assembled together, the first protrusion portions 3112 are in contact with the corresponding first through grooves 1234 of the ground terminal 1231 and extend through the first through grooves 1234 to the side of the cable 200, and are evenly spaced on both sides of the signal terminal pair 1221. a plurality of second protrusion portions 3113 are in contact with the corresponding second through grooves 1235 and extend through the second through grooves 1235, and are evenly spaced on both sides of the signal terminal pair 1221. The shielding plate 310 and the grounding member 123 are mechanically and electrically connected, which can effectively improve not only the crosstalk between adjacent signal terminal pairs 1221 but also the crosstalk between adjacent signal conductor pairs 210.

The inner layer plate 311 is provided with a plurality of oval reserved holes 3116, and the middle plate 312 and the outer plate 313 are provided with a plurality of oval and rectangular reserved holes 3116. When the inner plate 311, the middle plate 312 and the outer plate 313 are assembled together, the reserved hole 3116 exposes the connection between the signal conductor pair 210 and the signal terminal pair 1221, which facilitates the soldering of the signal conductor pair 310 and the signal terminal pair 1221. However, the signal conductor pair 210 does not extend through the reserved hole 3116. On the one hand, the rectangular reserved holes are provided to expose the connection between the signal conductor pair 210 and the signal terminal pair 1221, on the other hand, it is also convenient for the first protrusion portions 3112 to be folded. In the same way, the rectangular holes 3120 between the second protrusion portions 3113 also facilitate the folding of the second protrusion portions 3113. A plurality of welding portions 3117 are also provided above the outer plate 313 and are folded toward the inner plate 311. The welding portions 3117 are welded with the ground conductor 220. The width of the two outermost welding portions on the outer layer plate 313 is smaller than the width of the inner welding portion. The outermost welding part only needs to be welded with one ground conductor, while the inner welding part needs to be welded with two ground conductors disposed between the signal conductor pairs at the same time. In other embodiments, the size of the welding portion can be set according to specific design conditions. In addition, in order to firmly connect the shielding plate 310 and the frame 121, the plate portion 3111 of the inner plate 311, outer plate 313 and middle plate 312 are all provided with a plurality of the notches 3118 and through holes 3119 to match with the frame 121.

A shielding piece 320 is provided on the other side of the frame 121. The shielding piece 320 is connected with a plurality of first protrusion portions 3112 to form a plurality of openings 330 respectively surrounding each of the signal conductor pairs. In this embodiment, the shielding piece 320 includes a first shielding piece 321 and a second shielding piece 322. The first shielding piece 321 and the second shielding piece 322 are arranged symmetrically up and down with the cable 200 arrangement direction as the axis. The first shielding piece 321 includes a first horizontal part 3211 parallel to the extension direction of the signal conductor pair 210, and a first vertical part 3212 perpendicular to the first horizontal part 3211. The second shielding piece 322 includes a second horizontal part 3221 parallel to the extension direction of the signal conductor pair 210, and a second vertical part 3222 perpendicular to the second horizontal part 3221. The first horizontal part 3211 is disposed on the upper side of the first protrusion portion 3112, and the second horizontal part 3221 disposed on the lower side of the first protrusion portion 3112. The upper side of the first protrusion portion 3112 is provided with a first convex 3112A that is in direct contact with the first horizontal part 3211, and the lower side of the first protrusion portion 3112 is provided with a second convex 3112B that is in direct contact with the second horizontal part 3211, such a design enables the shielding plate 310 and the shielding piece 320 to be electrically connected. The first convex 3112A and the second convex 3112B are disposed on the first protrusion portion 3112 of the outer plate 313, that is, the first convex 3112A and the second protrusion are spaced on a plurality of first protrusion portions 3112. In other embodiments, a first convex 3112A and a second convex 3112B may also be provided on each first protrusion portion 3112 to achieve electrical connection between the shielding plate 310 and the shielding sheet 320. The adjacent first protrusion portions 3112 are connected with the first horizontal part 3211 and the second horizontal part 3221 to form a rectangular opening 330 to surround the each signal conductor pair 210, and the crosstalk between the signal conductor pair 210 is effectively improved. The first vertical part 3212 and the second vertical part 3222 are also provided with a plurality of notches 323 that match with the frame 121 to strengthen the connection between the shielding sheet 320 and the frame 121.

The ground conductor 220 extends upward along the shapes of the first horizontal portion 3211 and the first vertical portion 3212 and acrosses the ground member 123 through the groove 1233, and welded with the welding portion 3117 of the outer plate 313. Therefore, the ground conductor 220 does not directly contact the ground terminal 1231, but directly contacts the shielding plate 310, thereby achieving electrical connection between the ground conductor, the shielding plate and the grounding terminal 1231, forming a common ground connection, and effectively reducing resonance points.

Through the design of the shielding member, the electrical connector assembly in the present invention can provide better grounding and shielding performance and meet high-frequency characteristic requirements.

1. An electrical connector assembly comprising:
an electrical connector comprising:
a housing;
a frame disposed in the housing;
a terminal assembly and a grounding member which are configured to be supported in the frame, the terminal assembly comprising a plurality of signal terminal pairs and the grounding member comprising a plurality of ground terminals respectively provided on both sides of each pair of signal terminals; and
a shielding member which is configured to be electrically connected to the grounding member, the shielding member comprising a shielding plate; and
a cable connected with the electrical connector and comprising:
a plurality of signal conductor pairs which are configured to be connected to the signal terminal pairs; and
a plurality of ground conductors which are configured to be electrically connected to the ground terminals; wherein
the shielding plate comprises an inner plate disposed close to the grounding member, an outer plate disposed away from the grounding member, and an middle plate disposed between the inner plate and the outer plate, each of the inner plate, the outer plate, and the middle plate comprises a plate portion provided on the other side of the frame relative to the cable, each of the middle plate and the outer plate comprises a plurality of first protrusion portions extending from the plate portion through the frame to the side of the cable, and the plurality of first protrusion portions are disposed between adjacent pairs of signal conductors to reduce crosstalk between adjacent pairs of signal conductors.

2. The electrical connector assembly as claimed in claim 1, wherein the outer plate include a plurality of the second protrusion portions disposed below the first protrusion portions.

3. The electrical connector assembly as claimed in claim 2, wherein the first protrusion portions are disposed on the middle plate and the outer plate in a staggered manner, the middle plate and the inner plate are provided with through slots for the first protrusion portions and the second protrusion portions to extend through, so that when the inner plate, the middle plate, and the outer plate are assembled together, the first protrusion portions and the second protrusion portions extend through one side of the frame to the other side of the frame and are evenly spaced on both sides of the pair of signal terminals.

4. The electrical connector assembly as claimed in claim 1, wherein the plate portion of the inner plate, the middle plate, and the outer plate are each provided with a plurality of reserved holes corresponding to the connection positions of the signal conductor pairs and the signal terminal pairs to expose the connection positions, the signal conductor pair is connected to the signal terminal pair but does not extend through the reserved hole.

5. The electrical connector assembly as claimed in claim 1, wherein the shielding member includes a shielding piece disposed on the side of the cable and connected with the shielding plate.

6. The electrical connector assembly as claimed in claim 5, wherein the shielding piece is connected with a plurality of the first protrusion portions to form a plurality of openings respectively surrounding each pair of signal conductor.

7. The electrical connector assembly as claimed in claim 6, wherein the first protrusion portion is provided with a convex structure in direct contact with the shielding piece.

8. The electrical connector assembly as claimed in claim 7, wherein the shielding piece includes a first shielding piece and a second shielding piece arranged symmetrically up and down with the arrangement direction of the signal conductor pairs as an axis.

9. The electrical connector assembly as claimed in claim 8, wherein the first shielding piece includes a first horizontal part parallel to the extension direction of the signal conductor pair, and a first vertical part perpendicular to the first horizontal part; the second shielding piece includes a second horizontal part parallel to the extension direction of the signal conductor pair, and a second vertical part perpendicular to the second horizontal part.

10. The electrical connector assembly as claimed in claim 9, wherein the first protrusion portion includes a first convex directly contact with the first horizontal part on one side and a second convex directly contact with the second horizontal part, the adjacent first protrusion portions are connected with the first horizontal part and the second horizontal part to form a rectangular opening surrounding each pair of signal conductors.

11. The electrical connector assembly as claimed in claim 1, wherein the ground conductor is not directly mechanically connected to the ground terminal.

12. The electrical connector assembly as claimed in claim 9, wherein the outer plate includes a welding portion welded with the ground conductor.

13. The electrical connector assembly as claimed in claim 12, wherein the ground conductor extends upward along the shapes of the first horizontal part and the first vertical portion across the ground member and then is welded with the welding portion of the outer plate.
